(19) United States
(12) Patent Application Publication
(10) Pub. No.: US 2020/0318411 A1
(43) Pub. Date: Oct. 8, 2020

(54) Damped Hinge Assembly

(71) Applicant: Titus d.o.o. Dekani, Dekani (SI)

(72) Inventors: David Pecar, Pobegi (SI); Valter Svara, Izola (SI)

(21) Appl. No.: 16/304,794

(22) PCT Filed: May 19, 2017
(86) PCT No.: PCT/EP2017/062165

§ 371 Date: Nov. 27, 2018

(30) Foreign Application Priority Data
Jun. 2, 2016 (GB) 1609652.1

(51) Int. Cl. E05F 5/00; E05F 3/20

(52) U.S. Cl. CPC E05F 5/006; E05F 3/20; E05Y 2900/20; E05Y 2201/256; E05Y 2201/264; E05Y 2201/21

(57) ABSTRACT

A damper assembly is provided for a toggle-type hinge (41). The assembly comprises a linear damping device (10′), which is mounted via a radiussed groove (44) on a flange (43) of the hinge and held in place by a housing (45). A wing (16′) on the damping device is contactable by an arm (42) of the hinge in its closing movement. A mechanism converts closing movement of the hinge into linear actuation of the damping device. This mechanism includes two camming surfaces (19′, 25′) on the flange. A first one of these normally engages with the damping device, with the second one also engaging if the transmitted force exceeds a predetermined threshold.

This invention relates to damped hinge assemblies, and more particularly, to damper assemblies for use with toggle type hinges of the sort that are typically used on kitchen cupboards.

The invention provides a damper assembly for a hinge, comprising a linear damping device, retaining means for mounting the damping device on a hinge, and a mechanism for converting rotational movement of the hinge in at least part of one direction into linear actuation of the damping device, wherein the movement converting mechanism comprises two separate camming devices which are both capable of transmitting force.

By way of example, embodiments of the invention will now be described with reference to the accompanying drawings, in which:

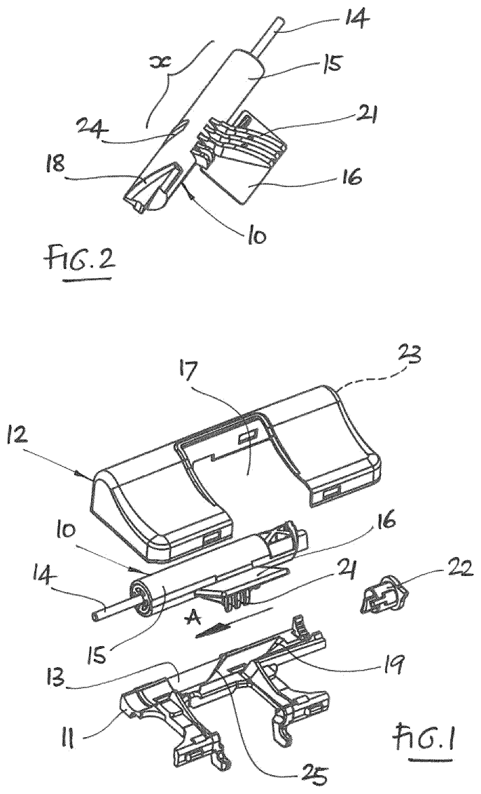

FIG. 1 is an exploded view showing the components of a first form of damper assembly according to the invention,

FIG. 2 is an underneath view of the damper unit of the damper assembly of FIG. 1,

FIG. 3 shows the damper assembly of FIG. 1 in position on a hinge, and

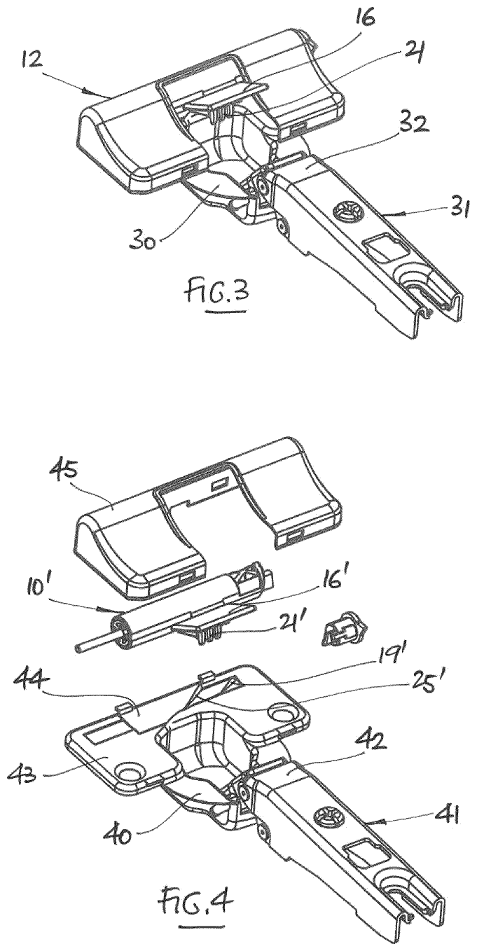

FIG. 4 is an exploded view showing the components of a second form of damper assembly for a hinge.

The form of damper assembly seen in exploded view in FIG. 1 is for mounting onto the hinge cup 30 of a toggle type hinge 31 (see FIG. 3) of the sort that is typically used for mounting a door on a kitchen cupboard. Such hinge and damper assemblies are known in the art and an example is seen in U.S. Pat. No. 8,186,014.

As seen in FIG. 1, the damper assembly comprises a damper unit 10, which in use is mounted on a bracket 11 and retained in position by a housing 12.

The damper unit 10 is in the form of an elongate linear piston and cylinder device, with a piston (not shown) arranged on the end of a piston rod 14 to be reciprocable within a cylinder 15 containing a damping fluid such as silicone, and with a compression spring (not shown) biasing the piston rod towards its extended position. The device is designed to produce a damped resistive force upon its compression, in known manner.

The damper unit 10 is mounted on the bracket 11 via an elongate, radiussed groove 13. This enables the damper unit 10 to have freedom to rotate about its longitudinal axis and to have freedom to move axially with respect to the bracket 11. The housing 12 is attachable to the bracket 11 by suitable means such as fasteners or spring clips and thereby retains the damper unit 10. The bracket 11 is itself attachable to the cup flange of the hinge by suitable means such as fasteners or spring clips, in known manner.

Extending laterally from the cylinder 15 is a wing 16, which in use protrudes out of an opening 17 in the housing 12. The wing 16 is designed to be engageable by an arm 32, which is part of the link mechanism of the hinge 31 (see FIG. 3), which thereby actuates the damper assembly on the closing movement of the door that the hinge mounts. A reinforcing structure 21 is provided on the wing 16 (seen best in FIG. 2) to strengthen its attachment to the cylinder 15 and provide sliding contact with the arm 32.

As seen best in FIG. 2, the cylinder 15 is provided with a camming surface 18 which extends helically with respect to its longitudinal axis. This camming surface 18 is designed to be engageable with a follower on the bracket 11, in this case in the form of a complementary camming surface 19 provided in the groove 13. The two camming surfaces 18, 19 together form a camming device that acts as a movement converting mechanism to translate rotational movement of the cylinder 15 (caused by actuation of the wing 16) into axial movement of the cylinder. In particular, the cylinder 15 is caused to move axially towards the free end of the piston rod 14 (in the direction of arrow A in FIG. 1) upon closing movement of the door. Since the free end of the piston rod 14 abuts against the inside of the housing 12, this movement of the cylinder 15 causes compression of the damper unit 10. The damper unit 10 thus generates in return a damped resistive force, which is transmitted via the wing 16 and hinge to the closing door, thus retarding its closing movement.

An end cap 22 is mounted in a hole 23 in the housing 12. The purpose of the end cap 22 is to allow adjustment of the axial end position of the cylinder 15. Adjusting the end position of the cylinder 15 effectively causes the rotational position of the wing 16 to vary, by operation of the two interengaging camming surfaces 18,19 of the camming device. Varying the rotational position of the wing 16 alters the point at which it is engaged by the arm 32 of the link mechanism of the hinge 31. Accordingly, adjustment of the end cap 22 effectively controls the damping response produced by the assembly.

To be fully useful, a damper assembly such as this must be capable of withstanding the forces generated by a slammed door. The helical profile of the camming device means that in addition to generating an axial component of force, it will also generate a radial component of force. When a door is slammed, the impact on the actuating wing 16 will be unusually high. This in turn means that an unusually high degree of radial force will be transmitted to the damper unit 10. In some cases, the radial force component can be sufficient to lead to distortion of the cylinder 15, potentially jamming the piston within it, or even causing a fatal fracture of the cylinder.

It will be noted that in the assembly seen in the drawings, the camming device is located at the end of the cylinder 15. In this position, the radial component of force generated by the slamming of a door will have least effect on the integrity of the cylinder 15. Moreover, the camming surface 18 is positioned on the cylinder 15 beyond the extent of the working stroke of the piston (indicated by the letter x in FIG. 2). This ensures that the cylinder 15 will experience minimal distortion over the effective working range of the piston, thereby reducing the risk of the piston jamming.

With the camming surface 18 being situated at the end of the cylinder 15, the camming device is axially spaced apart from the position of the wing 16, which is located in a central region of the cylinder. This separation gives rise to the possibility that impact forces acting on the wing 16 (from a closing door) and transmitted by the camming device might cause some destabilisation of the seating of the cylinder 15. In particular, there might be a tendency for the cylinder 15 to be prised out of its proper engagement with the groove 13 on the bracket 11, especially under heavy impact loads. Increasing the radial depth of the camming surface 18 will help to some extent in combatting this problem by spreading the load. However, a more effective solution is the addition of a second camming device.

As seen in FIG. 2, a second camming surface 24 is provided on the cylinder 15, here located in its central region and ideally, opposite the wing 16. The second camming surface 24 takes the form of a groove in the outer surface of the cylinder 15 and like the first camming surface 18, it extends helically about the longitudinal axis of the cylinder. The two camming surfaces 18 and 24 extend in the same direction and have the same pitch.

The second camming surface 24 on the cylinder 15 is designed to engage a follower, here in the form of a second camming surface 25 on the bracket 11, the two together forming the second camming device. The second camming surface 25 extends in the same direction as the first camming surface 19 on the bracket 11 and has the same pitch.

The two camming devices formed by the two pairs of interengaging camming surfaces 18,19 and 24,25 are designed to work in tandem when the wing 16 experiences heavy impact loads. The additional area of working surface helps to spread the load. Also, the positioning of the second camming device in the vicinity of the wing 16 helps to provide a more direct transmission of forces and hence less tendency for de-stabilisation of the cylinder 15.

At lower impact loads, it may not be necessary for the second camming device to come into operation. For that reason, the axial separation between the two camming surfaces 18,24 on the cylinder 15 is designed to be slightly greater than the axial separation between the two camming surfaces 19,25 on the bracket 11. This means that under normal loading, only the first camming device will be in engagement, whereas if the cylinder 15 experiences higher loads sufficient to distort it, this will additionally bring the second camming device into engagement. For this purpose, the difference in separation need only be small, for example in the order of 0.1-0.2 mm.

It will be noted that the form of damper assembly seen in FIG. 1 is capable of being retro-fitted to a hinge. The damper assembly seen in FIG. 4 is of a different form, where the hinge forms an integral part. The damper assembly is again designed for mounting onto the hinge cup 40 of a toggle type hinge 41 of the sort that is typically used for mounting a door on a kitchen cupboard. Again, the wing 16′ of the damper unit 10′ is arranged to be engaged by an arm 42 of the link mechanism of the hinge 41 to thereby actuate the damper assembly upon the closing movement of the door that it mounts.

The damper unit 10′ here is essentially the same as the damper unit 10 seen in FIGS. 1 and 2. In this case, however, the damper unit 10′ is mounted directly onto the hinge cup flange 43 itself. The damper unit 10′ is mounted via a radiussed groove 44 on the hinge cup flange 43. This enables the damper unit 10′ to have freedom to rotate about its longitudinal axis and to have freedom to move axially with respect to the hinge cup flange 43. The damper unit 10′ is retained in position by means of a housing 45, which is attachable to the hinge cup flange 43 by suitable means such as fasteners or spring clips, in known manner. In this case, the two helical camming surfaces 19′,25′ which together with the camming surfaces 18,24 on the cylinder 15 form the two camming devices that act as the movement converting mechanism, are formed as integral features of the hinge cup flange 43. In all other respects, the damper assembly of FIG. 4 operates in the same manner as the damper assembly of FIGS. 1, 2 and 3.

It will be appreciated that the camming devices that act as the movement converting mechanism described above could be configured in various other ways. For example, the roles of the two camming devices could be reversed. Also, the camming devices could be designed with one camming surface on the housing 12 and another on the bracket 11 or on the hinge cup flange 30,43. It would also be possible to provide the two camming devices at the same axial location, ie not spaced apart. For example, the camming devices could comprise two grooves in the outer surface of the cylinder, both extending helically around it, in the manner of a twin-start screw thread.

1. A damper assembly for a hinge, comprising a linear damping device, retaining means for mounting the damping device on a hinge, and a mechanism for converting rotational movement of the hinge in at least part of one direction into linear actuation of the damping device, wherein the movement converting mechanism comprises two separate camming devices which are both capable of transmitting force.

2. A damper assembly as claimed in claim 1 wherein the two camming devices are spaced apart in the direction of said linear actuation of the damping device.

3. A damper assembly as claimed in claim 2 wherein a first one of the camming devices is arranged to transmit force up to a predetermined threshold above which the second one of the camming devices is arranged additionally to transmit force.

4. A damper assembly as claimed in claim 3 wherein said camming devices comprise camming surfaces provided on the damping device.

5. A damper assembly as claimed in claim 4 wherein said camming surfaces are arranged to be engaged by respective followers on the retaining means.

6. A damper assembly as claimed in claim 5 wherein the retaining means includes a housing and at least one of said followers is provided on the housing.

7. A damper assembly as claimed in claim 5 wherein the hinge comprises a hinge cup flange and at least one of said followers is provided on the hinge cup flange or on a part connected thereto.

8. A damper assembly as claimed in claim 5 wherein said followers are spaced apart in the direction of said linear actuation of the damping device, and the spacing of the camming surfaces is slightly greater than the spacing of the followers.

9. A damper assembly as claimed in claim 5 wherein said followers are also in the form of camming surfaces.

10. A damper assembly as claimed in claim 5 wherein the damping device is in the form of a piston and cylinder damper and the first camming device is arranged to transmit force at a position substantially outside the range of movement of the piston on its working stroke.

11. A damper assembly as claimed in claim 10 wherein the working stroke of the piston is a compression of the damping device.

12. A damper assembly as claimed in claim 10 wherein the piston is mounted on a piston rod that has a free end extending out of the cylinder, and wherein movement of the piston on its working stroke is caused by movement of the cylinder.

13. A hinge assembly comprising a hinge and a damper assembly as claimed in claim 1.

14. A piece of furniture comprising a damper assembly as claimed in claim 1.

15. A damper assembly as claimed in claim 1 wherein a first one of the camming devices is arranged to transmit force up to a predetermined threshold above which the second one of the camming devices is arranged additionally to transmit force.

16. A damper assembly as claimed in claim 1 wherein said camming devices comprise camming surfaces provided on the damping device.

17. A damper assembly as claimed in claim 16 wherein said camming surfaces are arranged to be engaged by respective followers on the retaining means.

18. A damper assembly as claimed in claim 17 wherein the retaining means includes a housing and at least one of said followers is provided on the housing.

19. A damper assembly as claimed in claim 1 wherein the damping device is in the form of a piston and cylinder damper and the first camming device is arranged to transmit force at a position substantially outside the range of movement of the piston on its working stroke.

20. A damper assembly as claimed in claim 19 wherein the working stroke of the piston is a compression of the damping device.
